(19) United States
(12) Patent Application Publication
(10) Pub. No.: US 2023/0325571 A1
(43) Pub. Date: Oct. 12, 2023

(54) CELL LIBRARIES, COMPUTING SYSTEMS, AND METHODS FOR DESIGNING AN INTEGRATED CIRCUIT

(71) Applicant: Samsung Electronics Co., Ltd., Suwon-si (KR)

(72) Inventors: Juyeon Kim, Suwon-si (KR); Jaehoon Kim, Suwon-si (KR); Sun Ik Heo, Suwon-si (KR); Jun Seomun, Suwon-si (KR); Hyun-Seung Seo, Suwon-si (KR); Chul Rim, Suwon-si (KR); Chang Ho Han, Suwon-si (KR)

(21) Appl. No.: 18/149,749

(22) Filed: Jan. 4, 2023

(30) Foreign Application Priority Data
Apr. 7, 2022 (KR) 1020220043612

(51) Int. Cl. G06F 30/392

(52) U.S. Cl. CPC G06F 30/392; G06F 2119/12

(57) ABSTRACT

A cell library is provided. The cell library is stored in a computer-readable storage medium. The cell library is configured to store: first delay information of a standard cell according to a threshold voltage of a transistor included in the standard cell; and second delay information of the standard cell according to mobility of the transistor included in the standard cell.

### CROSS-REFERENCE TO RELATED APPLICATION

This application claims priority under 35 U.S.C. § 119 from Korean Patent Application No. 10-2022-0043612 filed on Apr. 7, 2022 in the Korean Intellectual Property Office, the disclosure of which is incorporated herein by reference in its entirety.

### BACKGROUND

The present disclosure relates to a cell library, a computing system for designing an integrated circuit by considering a local layout effect, and a method for designing the integrated circuit. An integrated circuit may be designed on the basis of (i.e., based on) standard cells. Specifically, a layout of the integrated circuit may be generated by placing the standard cells that define the integrated circuit and routing the placed standard cells.

As a semiconductor process is miniaturized, standard cells including patterns formed in a plurality of layers may not only include patterns of reduced size, but also the size of standard cells may be reduced. Accordingly, the standard cells included in the integrated circuit may be greatly affected by a peripheral structure (i.e., layout) thereof, and the influence of such peripheral layout may be referred to as a local layout effect (LLE) or a layout-dependent effect (LDE).

### SUMMARY

Aspects of the present disclosure provide a cell library that stores an amount of change in delay of a standard cell according to an amount of change in threshold voltage of a transistor of the standard cell, and an amount of change in delay of the standard cell according to an amount of change in mobility of the transistor of the standard cell.

Aspects of the present disclosure also provide a computing system for designing an integrated circuit that is capable of analyzing the timing of the integrated circuit regardless of the type of local layout effect.

Aspects of the present disclosure also provide a method for designing an integrated circuit that is capable of analyzing the timing of the integrated circuit regardless of the type of local layout effect.

According to some embodiments of the present disclosure, a cell library is stored in a computer-readable storage medium, wherein the cell library is configured to store: first delay information of a standard cell according to a threshold voltage of a transistor included in the standard cell; and second delay information of the standard cell according to mobility of the transistor included in the standard cell.

According to some embodiments of the present disclosure, a computing system includes a memory configured to store a program that designs an integrated circuit including a standard cell that includes a transistor; and a processor. The processor is configured to execute the program to: receive input data of the standard cell; measure an amount of change in first delay of the standard cell according to an amount of change in threshold voltage of the transistor; measure an amount of change in second delay of the standard cell according to the amount of change in mobility of the transistor; and store the amount of change in the first delay and the amount of change in the second delay, in a cell library.

According to some embodiments of the present disclosure, a computing system includes a memory configured to store a program for designing an integrated circuit; and a processor configured to execute the program to: place and route a plurality of standard cells that define the integrated circuit to generate layout data of the integrated circuit; and calculate delay of the integrated circuit, using an amount of change in delay of each of the plurality of standard cells according to an amount of change in threshold voltage of transistors included in each of the plurality of standard cells, and an amount of change in delay of each of the plurality of standard cells according to an amount of change in mobility of the transistors included in each of the plurality of standard cells.

According to some embodiments of the present disclosure, a method for designing an integrated circuit includes receiving input data of a standard cell including a transistor; adding a threshold voltage of the transistor and a mobility of the transistor to the input data as variables; changing the variables and measuring, using the changed variables, a first amount of change in delay of the standard cell according to an amount of change in threshold voltage of the transistor, and a second amount of change in delay of the standard cell according to an amount of change in mobility of the transistor; and storing the first and second amounts of change in the delay, in a cell library.

However, aspects of the present disclosure are not restricted to the those set forth above. The above and other aspects of the present disclosure will become more apparent to one of ordinary skill in the art to which the present disclosure pertains by referencing the detailed description of the present disclosure given below.

### BRIEF DESCRIPTION OF THE DRAWINGS

The above and other aspects and features of the present disclosure will become more apparent by describing in detail example embodiments thereof referring to the attached drawings, in which:

FIG. 1 is a diagram for explaining a computing system for designing an integrated circuit according to some embodiments;

FIG. 2 is a diagram for explaining a method for designing the integrated circuit according to some embodiments;

FIG. 3 is a flowchart for explaining the method for designing the integrated circuit according to some embodiments;

FIG. 4 is a flowchart for explaining a step of FIG. 3;

FIG. 5 is a diagram for explaining the method for designing the integrated circuit according to some embodiments;

FIG. 6 is a flowchart for explaining the method for designing the integrated circuit according to some embodiments;

FIGS. 7 to 15 are diagrams for explaining the method for designing the integrated circuit according to some embodiments of FIG. 6;

FIG. 16 is a diagram for explaining a computing system for designing the integrated circuit according to some embodiments;

FIG. 17 is a diagram for explaining the method for designing the integrated circuit according to some embodiments;

FIG. 18 is a diagram for explaining the method for designing the integrated circuit according to some embodiments;

FIG. 19 is a flowchart for explaining the method for designing the integrated circuit according to some embodiments; and

FIG. 20 is a flowchart for explaining a method for fabricating a semiconductor device according to some embodiments.

### DETAILED DESCRIPTION

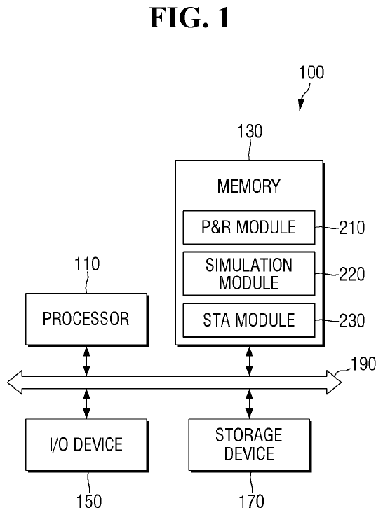

FIG. 1 is a diagram for explaining a computing system for designing an integrated circuit according to some embodiments.

Referring to FIG. 1, a computing system 100 for designing the integrated circuit according to some embodiments may include a processor 110, a memory 130, an input/output (I/O) device 150, a storage device 170, and a bus 190. The computing system 100 may be implemented, for example, as an integrated device. The computing system 100 may be provided, for example, as a dedicated device for designing the integrated circuit. The computing system 100 may be, for example, a computer for driving various simulation tools or design tools.

The processor 110 may be configured to execute a command that performs at least one of various behaviors/operations for designing the integrated circuit. The processor 110 may include, for example, a core capable of executing arbitrary commands such as a micro-processor, an application processor (AP), a digital signal processor (DSP), and a graphics processing unit (GPU).

The processor 110 may communicate with the memory 130, the I/O device 150, and the storage device 170 through the bus 190. The processor 110 may drive a Placement & Routing (P&R) module 210, a simulation module 220, and a Static Timing Analysis (STA) module 230 loaded into the memory 130 to design the integrated circuit. The P&R module 210, the simulation module 220, and the STA module 230 may be a program or software module including a plurality of commands executed by the processor 110, and may be stored in a non-transitory computer-readable storage medium.

The memory 130 may store the P&R module 210, the simulation module 220, and the STA module 230. The P&R module 210, the simulation module 220, and the STA module 230 may be loaded from, for example, the storage device 170. The memory 130 may be a volatile memory such as SRAM or DRAM, or may be a non-volatile memory such as PRAM, MRAM ReRAM, and FRAM NOR flash memory.

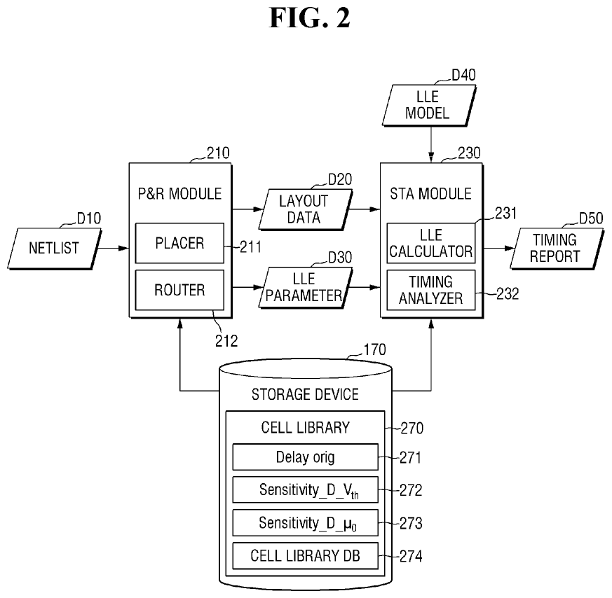

The P&R module 210, the simulation module 220, and the STA module 230 will be described in detail using FIGS. 2 to 15.

The I/O device 150 may control user input and output from the user interface devices. For example, the I/O device 150 includes an input device such as a keyboard, a mouse, and/or a touch pad, and may receive input data that defines the integrated circuit. For example, the I/O device 150 includes an output device such as a display and/or a speaker, and may display a placement result, a routing result, a timing analysis result, and/or the like.

The storage device 170 may store various data related to the P&R module 210, the simulation module 220, and the STA module 230. The storage device 170 may store the cell library. The storage device 170 may include, for example, a memory card (MMC, eMMC, SD, MicroSD, etc.), a solid state drive (SSD), a hard disk drive (HDD), and/or the like.

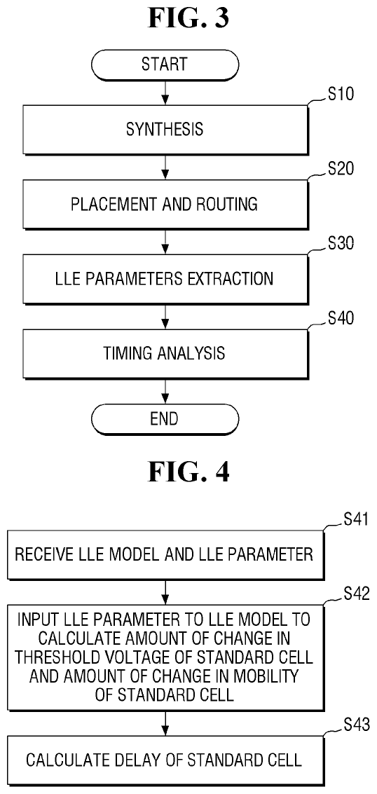

FIG. 2 is a diagram for explaining a method for designing the integrated circuit according to some embodiments. FIG. 3 is a flowchart for explaining the method for designing the integrated circuit according to some embodiments. FIG. 2 is a diagram that shows FIG. 1 in detail.

Referring to FIG. 2, the P&R module 210 may include a placer 211 and a router 212. The STA module 230 may include a Local Layout Effect (LLE) calculator 231 and a timing analyzer 232. As used herein, a configuration in which the processor 110 of FIG. 1 executes/controls the P&R module 210 and the STA module 230 to perform a behavior/operation is represented as a configuration in which the P&R module 210 and the STA module 230 perform such a behavior/operation.

The storage device 170 may include a cell library 270. The cell library 270 may store delay information 271 of each standard cell in a specific environment (e.g., with respect to the specific environment of each standard cell), delay information 272 according to (e.g., based on) a threshold voltage of each standard cell, delay information 273 according to (e.g., based on) the mobility of each standard cell, and a cell library database 274, which is information about the standard cells used to generate the layout of the integrated circuit. For convenience of description, the delay information 272 may be referred to herein as “first” delay information and the delay information 273 may be referred to herein as “second” delay information. Moreover, the storage device 170 is an example of a non-transitory computer-readable storage medium.

Referring to FIGS. 2 and 3, a synthesis behavior/operation may be performed (S10). The synthesis may mean a behavior/operation that generates a netlist D10 by converting the input data of an integrated circuit into a hardware form consisting of logic gates, and may be referred to as a logic synthesis. The input data may be an abstract form of the behavior/operation of the integrated circuit, for example, data defined by Register Transfer Level (RTL). The netlist D10 may be generated from an RTL code using the cell library 270 stored in the storage device 170, and may be the netlist D10 of a gate level. For example, the netlist D10 may be performed by the processor 110 using a synthesis module. For example, the synthesis module may receive the RTL code to output the netlist D10.

The standard cells that define the integrated circuit may be placed and routed according to the netlist D10 to generate layout data D20 of the integrated circuit (S20). The placer 211 of the P&R module 210 may access the cell library database 274 to place standard cells according to the netlist D10. The router 212 of the P&R module 210 may perform routing on the standard cells placed by the placer 211 to generate the layout data D20. The router 212 may store the layout data D20 in the cell library 270. The layout data D20 may be, for example, data of a Graphic Design System (GDS) II type.

A Local Layout Effect (LLE) parameter D30 may be extracted from the layout data D20 (S30). The P&R module 210 may extract the LLE parameter D30 from each standard cell included in the layout data D20. The P&R module 210 may extract the LLE parameter D30 for each transistor included in each standard cell. At this time, the P&R module 210 may extract the LLE parameter D30 for each transistor placed at a boundary of each standard cell. The P&R module 210 may receive the netlist D10 to output the layout data D20 and the LLE parameter D30. The P&R module 210 may store the LLE parameter D30 in the cell library 270.

The LLE parameter D30 may be a parameter that causes the local layout effect generated from the layouts placed around the standard cell. The LLE parameter D30 may include, for example, presence or absence of an active pattern placed around the standard cell, a shape of the active pattern, a size of the active pattern, a distance to the active pattern, and/or the like. The LLE parameter D30 may include, for example, a distance from the standard cell to the active pattern of a tapered shape, a width of the nanosheet of the active pattern adjacent to the standard cell, and/or the like.

Timing analysis of the integrated circuit may be performed (S40). The STA module 230 may calculate the delay of the standard cell included in the integrated circuit. The STA module 230 may generate a timing report D50 that includes a delay of the standard cell. The STA module 230 may receive the layout data D20, the LLE parameter D30, the LLE model D40, and the delay information 271, 272 and 273 stored in the cell library 270 to output the timing report D50. The STA module 230 may further determine whether the delay of the calculated standard cell satisfies a set (e.g., predetermined) condition to generate the timing report D50.

The integrated circuit may include the plurality of standard cells. The STA module 230 may calculate the delay of each standard cell included in the integrated circuit to generate the timing report D50 including the same. The STA module 230 may calculate the delay of the integrated circuit on the basis of the delay of each standard cell and generate the timing report D50 further including the same. The STA module 230 may further determine whether the delay of the integrated circuit satisfies the set condition to generate the timing report D50. This will be described in detail using FIGS. 3 and 4.

A method for designing an integrated circuit according to some embodiments may further include a step of performing Engineering Change Orders (ECOs) according to the timing analysis performed in step S40. Alternatively, the method for designing the integrated circuit according to some embodiments may perform the placement and routing behaviors/operations of the standard cells of step S20 again according to the timing analysis performed in step S40. For example, clock tree synthesis or optimization included in placement and routing behaviors/operations of the standard cells may be performed. As still another example, the metal routing included in the placement and routing behaviors of the standard cells may be modified.

FIG. 4 is a flowchart for explaining step S40 of FIG. 3.

Referring to FIGS. 2 and 4, the STA module 230 may receive the LLE model D40 and the LLE parameter D30 (S41). The STA module 230 may receive the LLE parameter D30 from the P&R module 210. The STA module 230 may receive the LLE parameter D30 extracted from the P&R module 210 for each transistor placed at the boundary of the standard cell.

The STA module 230 may receive the LLE model D40 through, for example, the I/O device 150 of FIG. 1. As another example, the STA module 230 may read the LLE model D40 stored in the storage device 170 of FIG. 1. The LLE model D40 may receive the LLE parameter D30 to output information about a change in physical characteristics of the standard cell according to the LLE effect. The information about the change in the physical characteristics of the standard cell may include an amount of change in threshold voltage of the standard cell and an amount of change in mobility of the standard cell. The amount of change in threshold voltage of the standard cell may include an amount of change in threshold voltage of each transistor placed at the boundary of the standard cell, and the amount of change in mobility of the standard cell may include an amount of change in mobility of each transistor placed at the boundary of the standard cell.

The LLE calculator 231 of the STA module 230 may input the LLE parameter D30 to the LLE model D40 to calculate the amount of change in threshold voltage of the standard cell and the amount of change in mobility of the standard cell (S42). The amount of change in threshold voltage of the standard cell may include the amount of change in threshold voltage of each transistor placed at the boundary of the standard cell. The amount of change in mobility of the standard cell may include the amount of change in mobility of each transistor placed at the boundary of the standard cell.

The timing analyzer 232 of the STA module 230 may calculate the delay of the standard cell (S43). The timing analyzer 232 may calculate the delay of the standard cell, by utilizing the delay information 271 in the specific environment of the standard cell, the delay information 272 according to the threshold voltage of the standard cell and the delay information 273 according to the mobility of the standard cell, which are stored in the cell library 270, and the amount of change in threshold voltage of the standard cell and the amount of change in mobility of the standard cell calculated in step S42. The delay information 272 according to the threshold voltage of the standard cell stored in the cell library 270 may include the amount of change in the delay of the standard cell according to the amount of change in threshold voltage of each transistor placed at the boundary of the standard cell. The delay information 273 according to the mobility of the standard cell stored in the cell library 270 may include the amount of change in the delay of the standard cell according to the amount of change in mobility of each transistor placed at the boundary of the standard cell.

The timing analyzer 232 may calculate the delay of the standard cell using Formula 1 for the standard cell. Formula 1 represents the delay of one standard cell. In Formula 1, n means the number of transistors placed at the boundary of the standard cell.

$$Delay = \qquad ( Formula 1 )$$

$$Delay orig + {\sum }_{i = 1}^{n} \frac{\partial Delay}{\partial Vth , tr\_i} Δ Vth , tr\_i + {\sum }_{i = 1}^{n} \frac{\partial Delay}{\partial μ 0 , tr\_i} Δ μ 0 , tr\_i$$

The timing analyzer 232 may calculate the delay of the standard cell by adding delay (Delay orig) of the standard cell in a specific environment, a product of an amount of change

$$( \frac{\partial Delay}{Δ Vth , tr\_i} )$$

in the delay of the standard cell according to the amount of change in threshold voltage of each transistor (tr_i) placed at the boundary of the standard cell and an amount of change (ΔVth, tr_i) in the threshold voltage of each transistor (tr_i) placed at the boundary of the standard cell, and a product of an amount of change

$$( \frac{\partial Delay}{\partial μ 0 , tr\_i} )$$

in the delay of the standard cell according to the amount of change in mobility of each transistor (tr_i) placed at the boundary of the standard cell and an amount of change (Δμ0, tr_i) in the mobility of each transistor (tr_i) placed at the boundary of the standard cell.

The timing analyzer 232 may receive the delay (Delay orig) 271 of the standard cell in the specific environment, the amount of change

$$( \frac{\partial Delay}{\partial Vth , tr\_i} )$$

272 in the delay of the standard cell according to the amount of change in threshold voltage of each transistor placed at the boundary of the standard cell, and the amount of change

$$( \frac{\partial Delay}{\partial μ 0 , tr\_i} )$$

273 in the delay of the standard cell according to the amount of change in mobility of each transistor placed at the boundary of the standard cell from the cell library 270, and may receive the amount of change (ΔVth, tr_i) in the threshold voltage of each transistor placed at the boundary of the standard cell, and the amount of change (Δβ0, tr_i) in the mobility of each transistor placed at the boundary of the standard cell from the LLE calculator 231. The LLE calculator 231 may input the LLE parameter to the LLE model to calculate the amount of change (ΔVth, tr_i) in the threshold voltage of each transistor placed at the boundary of the standard cell, and the amount of change (Δμ0, tr_i) in the mobility of each transistor placed at the boundary of the standard cell.

The integrated circuit may include a plurality of standard cells. The STA module 230 may perform steps S41 to S43 for each standard cell. Specifically, the P&R module 210 may extract the LLE parameter D30 from each transistor placed at the boundary of each standard cell, and the LLE calculator 231 may calculate the amount of change in threshold voltage and the amount of change in mobility of each transistor placed at the boundary of each standard cell by the use of the LLE model D40. The timing analyzer 232 may calculate the delay of each standard cell, by the use of the delay information 271 in the specific environment of each standard cell, the delay information 272 according to the threshold voltage of each standard cell and the delay information 273 according to the mobility of each standard cell stored in the cell library 270, and the amount of change in threshold voltage of each standard cell and the amount of change in mobility of each standard cell calculated by the LLE calculator 231. The delay information 272 according to the threshold voltage of each standard cell stored in the cell library 270 may include the amount of change in the delay (e.g., a first delay) of each standard cell according to the amount of change in threshold voltage of each transistor placed at the boundary of each standard cell. The delay information 273 according to the mobility of each standard cell stored in the cell library 270 may include the amount of change in the delay (e.g., a second delay) of each standard cell according to the amount of change in mobility of each transistor placed at the boundary of each standard cell.

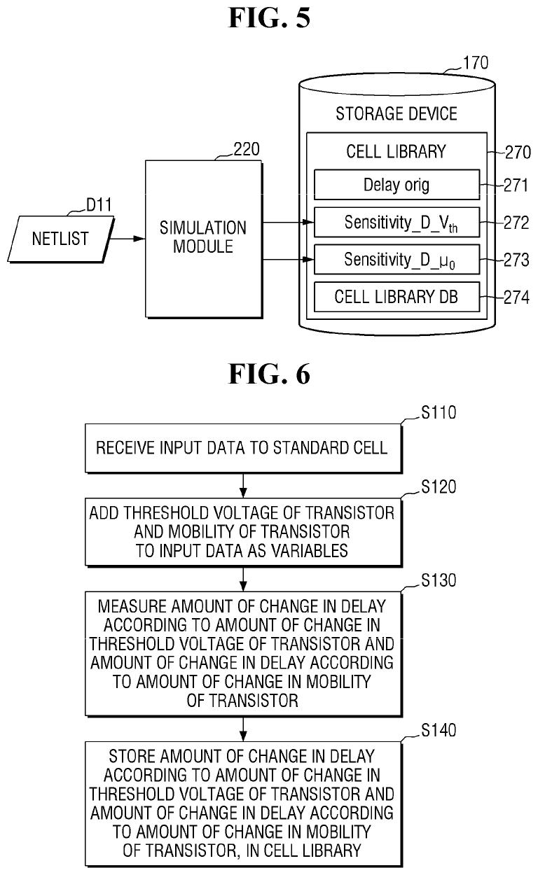

FIG. 5 is a diagram for explaining the method for designing the integrated circuit according to some embodiments. FIG. 6 is a flowchart for explaining the method for designing the integrated circuit according to some embodiments. FIG. 5 is a diagram that shows FIG. 1 in detail.

Referring to FIGS. 5 and 6, the simulation module 220 may receive input data D11 for the standard cell (S110). The input data D11 may be a Netlist.

The simulation module 220 may add the threshold voltage of each transistor and the mobility of each transistor to the input data D11 as variables (S120). At this time, the simulation module 220 may perform step S120 on each transistor placed at the boundary of the standard cell.

The simulation module 220 may measure the amount of change in the delay of the standard cell according to the amount of change in the threshold voltage of each transistor, and the amount of change in the delay of the standard cell according to the amount of change in mobility of each transistor (S130). At this time, the simulation module 220 may perform step S130 on each transistor placed at the boundary of the standard cell.

The simulation module 220 may store the amount of change in the delay of the standard cell according to the amount of change in threshold voltage of each transistor, and the amount of change in the delay of the standard cell according to the amount of change in the mobility of each transistor, in the cell library 270 (S140). The amount of change in the delay of the standard cell according to the amount of change in the threshold voltage of each transistor may be stored as the delay information 272 according to the threshold voltage of the standard cell of the cell library 270. The amount of change in the delay of the standard cell according to the amount of change in the mobility of each transistor may be stored as the delay information 273 according to the mobility of the standard cell of the cell library 270.

The method for designing the integrated circuit according to some embodiments may characterize (e.g., define) the local layout effect of the standard cell by the threshold voltage of the transistor and the mobility of the transistor. That is, regardless (e.g., independent) of the type of local layout effect, the local layout effect of the standard cell may be characterized by the threshold voltage of the transistor and the mobility of the transistor. Therefore, it is not necessary to devise a method for analyzing the timing of standard cell according to the type of local layout effect. Moreover, it is not necessary to perform the characterization behavior/operation for each type of local layout effect.

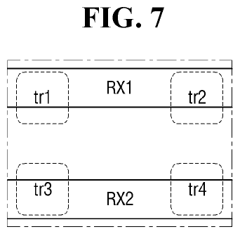

FIGS. 7 to 15 are diagrams for explaining a method for designing the integrated circuit according to some embodiments of FIG. 6.

Referring to FIG. 7, the standard cell may include a first active pattern RX1, a second active pattern RX2, and first to fourth transistors tr1, tr2, tr3 and tr4 placed at the boundary of the standard cell.

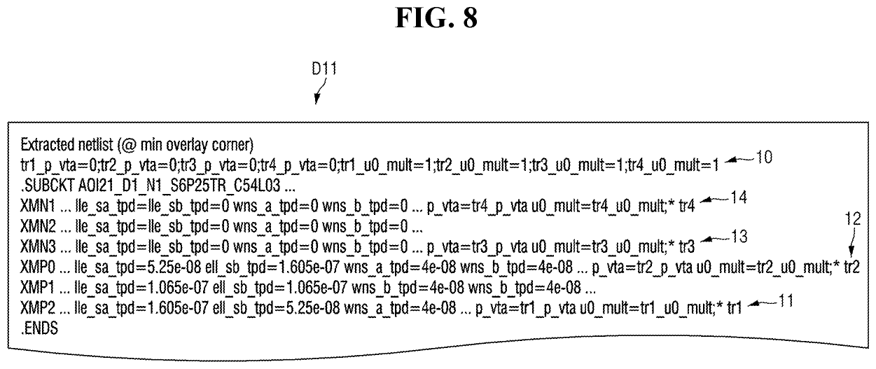

Referring to FIGS. 7 and 8, in the input data D11, a threshold voltage (tr1_p_vta) of the first transistor tr1 and a mobility (tr1_u0_mult) of the first transistor tr1 may be defined (11), a threshold voltage (tr2_p_vta) of the second transistor tr2 and a mobility (tr2_u0_mult) of the second transistor tr2 may be defined (12), a threshold voltage (tr3_p_vta) of the third transistor tr3 and a mobility (tr3_u0_mult) of the third transistor tr3 may be added as a definition (13), a threshold voltage (tr4_p_vta) of the fourth transistor tr4 and a mobility (tr4_u0_mult) of the fourth transistor tr4 may be defined (14). The threshold voltage (tr1_p_vta) of the first transistor tr1, the threshold voltage (tr2_p_vta) of the second transistor tr2, the threshold voltage (tr3_p_vta) of the third transistor tr3, the threshold voltage (tr4_p_vta) of the fourth transistor tr4, the mobility (tr1_u0_mult) of the first transistor tr1, the mobility (tr2_u0_mult) of the second transistor tr2, the mobility (tr3_u0_mult) of the third transistor tr3, and the mobility (tr4_u0_mult) of the fourth transistor tr4 may be added to the input data D11, as variables (10). For example, the threshold voltage (tr1_p_vta) of the first transistor tr1, the threshold voltage (tr2_p_vta) of the second transistor tr2, the threshold voltage (tr3_p_vta) of the third transistor tr3, and the threshold voltage (tr4_p_vta) of the fourth transistor tr4 may be set to 0, and the mobility (tr1_u0_mult) of the first transistor tr1, the mobility (tr2_u0_mult) of the second transistor tr2, the mobility (tr3_u0_mult) of the third transistor tr3, and the mobility (tr4_u0_mult) of the fourth transistor tr4 may be set to 1.

For example, the variable 10 may be added to the input data D11, using Layout Versus Schematic (LVS).

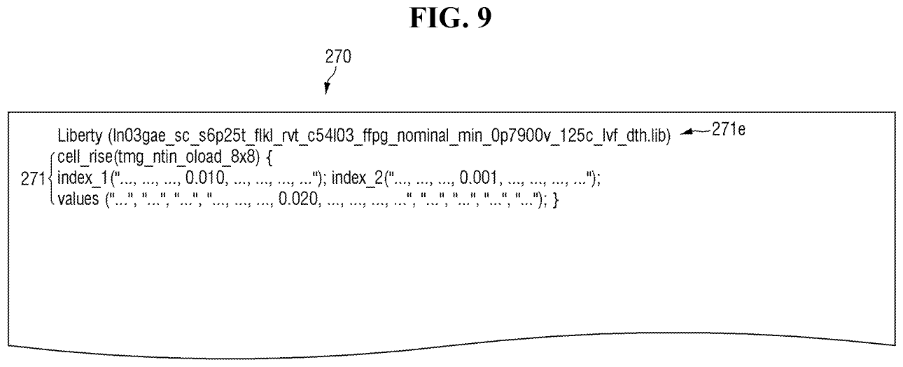

Referring to FIGS. 7 and 9, the cell library 270 may store a delay 271 in a specific environment 271e of the standard cell for the input data D11 of FIG. 8. The delay 271 of the standard cell in the specific environment 271e may be, for example, 20 picoseconds (ps). The specific environment 271e may include, for example, a voltage that is input to the standard cell, a temperature of the standard cell, and/or the like.

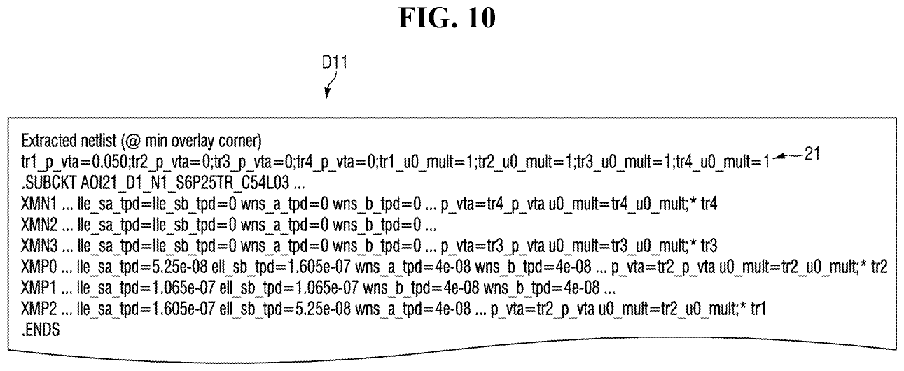

Referring to FIGS. 7 and 10, the variable 21 of the input data D11 may be changed. For example, a threshold voltage tr_1_p_vta of the first transistor tr1 may be changed from 0 to 50 millivolts (mV). That is, an amount of change in threshold voltage tr_1_p_vta of the first transistor tr1 may be 50 mV. The amount of change in the delay of the standard cell when the amount of change in the threshold voltage tr_1_p_vta of the first transistor tr1 is 50 mV may be measured.

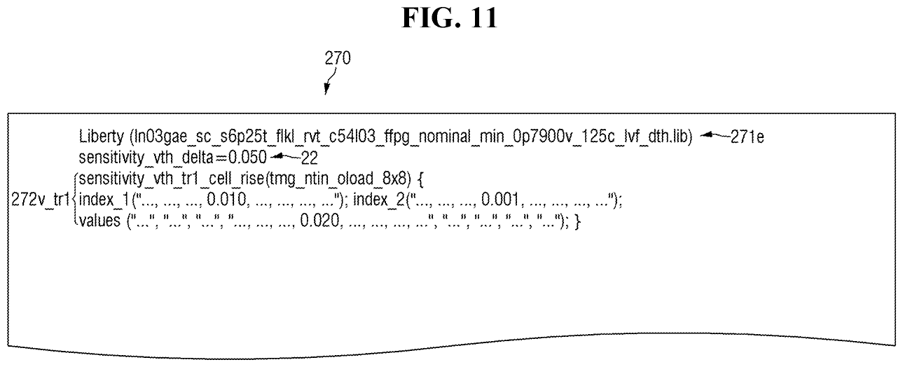

Referring to FIGS. 7 and 11, the cell library 270 may store the amount of change (22) in the threshold voltage of the first transistor tr1 and the accompanying amount of change (272_v_tr1) in the delay of the standard cell. For example, when the amount of change (22) in the threshold voltage of the first transistor tr1 is 50 mV, the amount of change (272_v_tr1) in the delay of the standard cell may be 4 ps. That is, in this case, the delay of the standard cell may be 24 ps, as 20 ps+4 ps=24 ps.

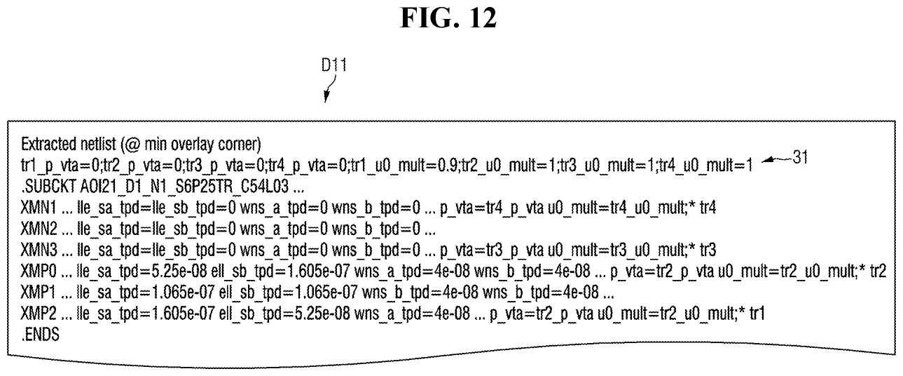

Referring to FIGS. 7 and 12, the variable 31 of the input data D11 may be changed. For example, the mobility (tr1_u0_mult) of the first transistor tr1 may be changed from 1 to 0.9. That is, the amount of change in the mobility (tr1_u0_mult) of the first transistor tr1 may be −0.1. The amount of change in the delay of the standard cell when the amount of change in the mobility (tr1_u0_mult) of the first transistor tr1 is −0.1 may be measured.

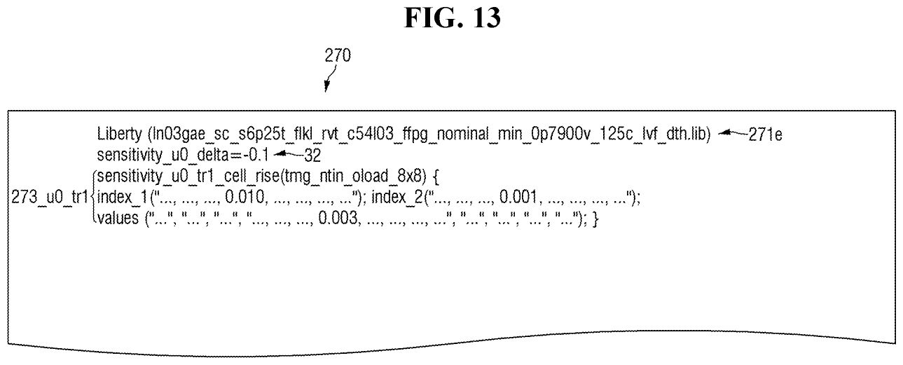

Referring to FIGS. 7 and 13, the cell library 270 may store the amount of change (32) in the mobility of the first transistor tr1 and the accompanying amount of change (273_u0_tr1) in the delay of the standard cell. For example, when the amount of change (32) in the mobility of the first transistor tr1 is −0.1, the amount of change (273_u0_tr1) in the delay of the standard cell may be 3 ps. That is, in this case, the delay of the standard cell may be 23 ps, as 20 ps+3 ps=23 ps.

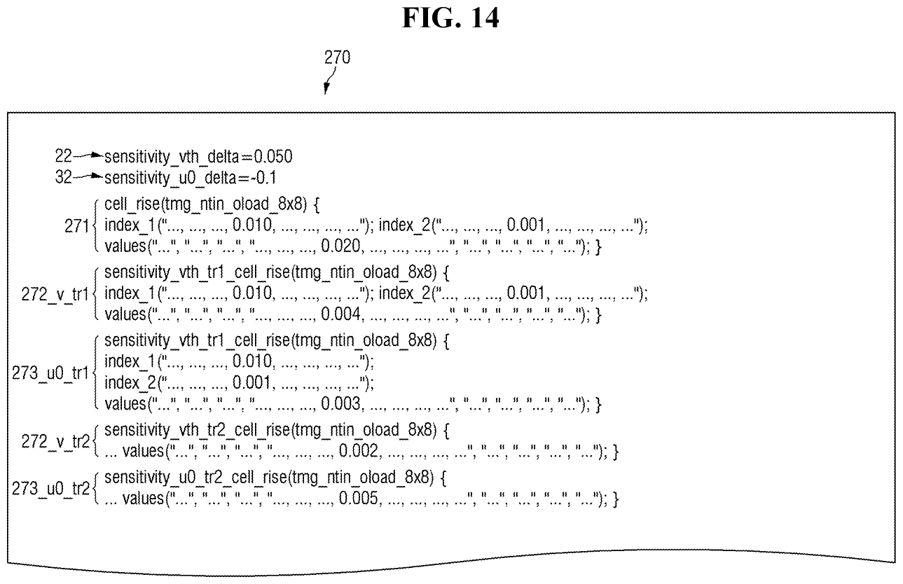

Subsequently, the amount of change in the delay of the standard cell according to the amount of change in threshold voltage and the amount of change in the delay of the standard cell according to the amount of change in the mobility may be repeatedly measured on the second to fourth transistors tr2, tr3, and tr4. Referring to FIGS. 7 and 14, the cell library 270 may store an amount of change (272_v_tr2) in the delay of the standard cell when the amount of change (22) in the threshold voltage of the second transistor tr2 is 50 mV, and an amount of change (273_u0_tr2) in the delay of the standard cell when the amount of change (32) in the mobility of the second transistor tr2 is −0.1. For example, when the amount of change (22) in the threshold voltage of the second transistor tr2 is 50 mV, the amount of change (272_v_tr2) in the delay of the standard cell may be 2 ps. That is, in this case, the delay of the standard cell may be 22 ps, as 20 ps+2 ps=22 ps. For example, when the amount of change (32) in the mobility of the second transistor tr2 is −0.1, the amount of change (273_u0_tr2) in the delay of the standard cell may be 5 ps. That is, in this case, the delay of the standard cell may be 25 ps, as 20 ps+5 ps=25 ps.

The cell library 270 may store the amount of change in the delay of the standard cell when the amount of change (22) in the threshold voltage of the third transistor tr3 is 50 mV, the amount of change in the delay of the standard cell when the amount of change (32) in the mobility of the second transistor tr2 is −0.1, the amount of change in the delay of the standard cell when the amount of change (22) in the threshold voltage of the fourth transistor tr4 is 50 mV, and the amount of change in the delay of the standard cell when the amount of change (32) in the mobility of the fourth transistor tr4 is −0.1.

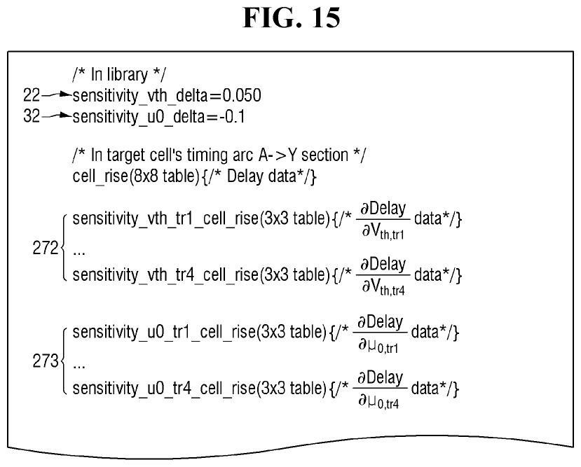

Referring to FIG. 15, as a result, the cell library 270 may store the amount of change (22) in the threshold voltage of the first to fourth transistors tr1, tr2, tr3, and tr4 placed at the boundary of the standard cell, the amount of change (32) in the mobility of the first to fourth transistors tr1, tr2, tr3, and tr4 placed at the boundary of the standard cell, the amount of change (272) in the delay of the standard cell according to the amount of change in the threshold voltage of each of the first to fourth transistors tr1, tr2, tr3, and tr4, and the amount of change (273) in the delay of the standard cell according to the amount of change (32) in the mobility of each of the first to fourth transistors tr1, tr2, tr3, and tr4. The amount of change (272) in the delay of the standard cell according to the amount of change (22) in the threshold voltage of each of the first to fourth transistors tr1, tr2, tr3, and tr4 of FIG. 15 may correspond to the delay information 272 according to the threshold voltage of the standard cell of FIG. 2, and the amount of change (273) in the delay of the standard cell according to the amount of change (32) in the mobility of each of the first to fourth transistors tr1, tr2, tr3, and tr4 of FIG. 15 may correspond to the delay information 273 according to the mobility of the standard cell of FIG. 2.

Behaviors/operations S110 to S140 of FIG. 6 may be performed on each standard cell, and they may be stored in the delay information 272 according to the threshold voltage of the standard cell of FIG. 2 and the delay information 273 according to the mobility of the standard cell. That is, as shown in FIG. 15, the delay information 272 according to the threshold voltage of the standard cell and the delay information 273 according to the mobility of the standard cell may be stored for each standard cell.

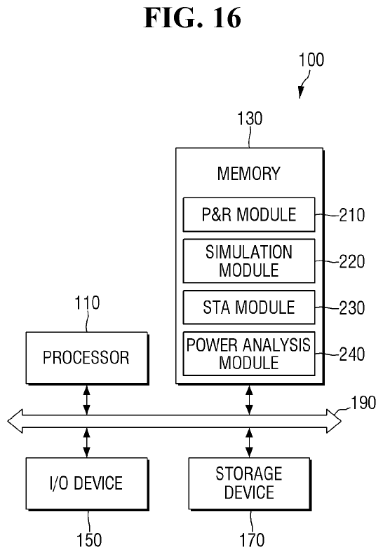

FIG. 16 is a diagram for explaining a computing system for designing the integrated circuit according to some embodiments. For convenience of explanation, points different from those described using FIGS. 1 to 15 will be mainly described.

Referring to FIG. 16, in a computing system 100 for designing the integrated circuit according to some embodiments, the memory 130 may further include a power analysis module 240. The power analysis module 240 may be loaded from, for example, the storage device 170.

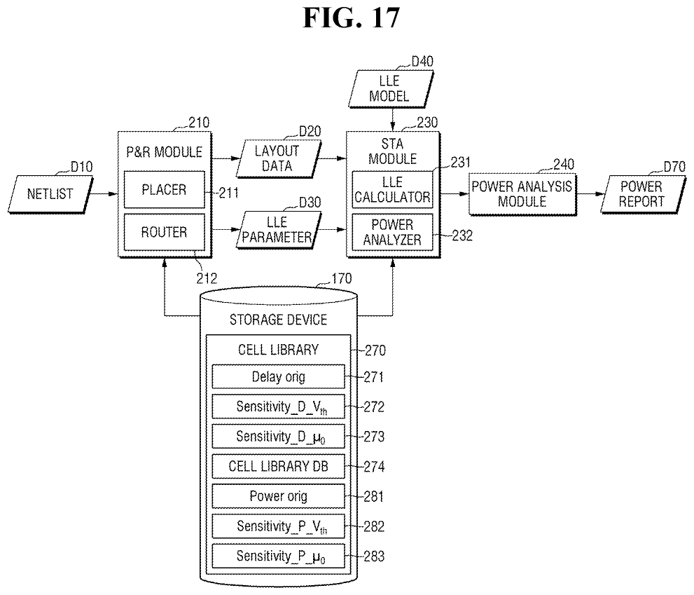

FIG. 17 is a diagram for explaining the method for designing the integrated circuit according to some embodiments. FIG. 17 is a diagram that shows FIG. 16 in detail.

Referring to FIG. 17, the storage device 170 may include the cell library 270. The cell library 270 may further include power information 281 of each standard cell in a specific environment, power information 282 according to the threshold voltage of each standard cell, and power information 283 according to the mobility of each standard cell.

The power analysis module 240 may calculate the power of the standard cell included in the integrated circuit. The power analysis module 240 may generate a power report D70 including the power of the standard cell. The power analysis module 240 may receive the amount of change in the threshold voltage of the standard cell and the amount of change in the mobility of the standard cell calculated by inputting the LLE parameter D30 to the LLE model D40 from the LLE calculator 231, and the power information 281, 282 and 283 stored in the cell library 270, and output the power report D70. The power analysis module 240 may further determine whether the calculated power of the standard cell satisfies a set condition to generate the power report D70.

The integrated circuit may include the plurality of standard cells. The power analysis module 240 may calculate the power of each standard cell included in the integrated circuit to generate the power report D70 including the same. The power analysis module 240 may calculate the power of the integrated circuit on the basis of the power of each standard cell, and may generate the power report D70 further including the same. The power analysis module 240 may further determine whether the power of the integrated circuit satisfies the set condition to generate the power report D70.

The method for designing the integrated circuit according to some embodiments may further include a step of performing ECOs according to the power report D70. Alternatively, the method for designing the integrated circuit according to some embodiments may perform the placement and routing behaviors of the standard cell of step S20 according to the power report D70 again. For example, clock tree synthesis or optimization included in the placement and routing behaviors of the standard cells may be performed. As another example, the metal routing included in the placement and routing behaviors of the standard cells may be modified.

The power analysis module 240 may calculate the power of the standard cell. The power analysis module 240 may calculate the power of the standard cell by the use of power information 281 in a specific environment of the standard cell, power information 282 according to the threshold voltage of the standard cell, and power information 283 according to the mobility of the standard cell, which are stored in the cell library 270, and the amount of change in threshold voltage of the standard cell and the amount of change in mobility of the standard cell calculated by inputting the LLE parameter D30 to the LLE model D40. The power information 282 according to the threshold voltage of the standard cell stored in the cell library 270 may include the amount of change in the power of the standard cell according to the amount of change in threshold voltage of each transistor placed at the boundary of the standard cell. The power information 283 according to the mobility of the standard cell stored in the cell library 270 may include the amount of change in the power of the standard cell according to the amount of change in mobility of each transistor placed at the boundary of the standard cell.

The power analysis module 240 may calculate the power of the standard cell using Formula 2 for the standard cell. Formula 2 represents the power of one standard cell. In Formula 2, n means the number of transistors placed at the boundary of the standard cell.

$$Power = \qquad ( Formula 2 )$$

$$Power orig + {\sum }_{i = 1}^{n} \frac{\partial Power}{\partial Vth , tr\_i} Δ Vth , tr\_i + {\sum }_{i = 1}^{n} \frac{\partial Power}{\partial μ 0 , tr\_i} Δμ 0 , tr\_i$$

The power analysis module 240 may calculate the power of the standard cell, by adding power (Power orig) of a standard cell in a specific environment, a product of an amount of change

$$( \frac{\partial Power}{\partial Vth , tr\_i} )$$

in power of the standard cell according to an amount of change in threshold voltage of each transistor (tr_i) placed at the boundary of the standard cell and an amount of change (ΔVth, tr_i) in threshold voltage of each transistor (tr_i) placed at the boundary of the standard cell, and a product of an amount of change

$$( \frac{\partial Power}{\partial μ 0 , tr\_i} )$$

in power of the standard cell according to the amount of change in mobility of each transistor (tr_i) placed at the boundary of the standard cell and an amount of change (Δμ0, tr_i) in mobility of each transistor (tr_i) placed at the boundary of the standard cell.

The power analysis module 240 may receive the power (Power orig) 281 of the standard cell in a specific environment, the amount of change

$$( \frac{\partial Power}{\partial Vth , tr\_i} )$$

282 (e.g., a first amount of change) in power of the standard cell according to the amount of change in threshold voltage of each transistor placed at the boundary of the standard cell, and the amount of change

$$( \frac{\partial Power}{\partial μ 0 , tr\_i} )$$

283 (e.g., a second amount of change) in power of the standard cell according to the amount of change in mobility of each transistor placed at the boundary of the standard cell from the cell library 270, and may receive the amount of change (ΔVth, tr_i) in threshold voltage of each transistor placed at the boundary of the standard cell, and the amount of change (Δμ0, tr_i) in mobility of each transistor placed at the boundary of the standard cell from the LLE calculator 231. The LLE calculator 231 may input the LLE parameter D30 to the LLE model D40, and calculate the amount of change (ΔVth, tr_i) in threshold voltage of each transistor placed at the boundary of the standard cell, and the amount of change (Δμ0, tr_i) in mobility of each transistor placed at the boundary of the standard cell.

The integrated circuit may include the plurality of standard cells. The power analysis module 240 may calculate the power on each standard cell. Specifically, the P&R module 210 may extract the LLE parameter D30 from each transistor placed at the boundary of each standard cell, and the LLE calculator 231 may calculate the amount of change in threshold voltage and the amount of change in mobility of each transistor placed at the boundary of each standard cell, using the LLE model D40. The power analyzer 232 may calculate power of each standard cell by the use of power information 281 in a specific environment of each standard cell, power information 282 according to the threshold voltage of each standard cell, and power information 283 according to mobility of each standard cell, which are stored in the cell library 270, and the amount of change in threshold voltage of each standard cell and the amount of change in mobility of each standard cell calculated by the LLE calculator 231. The power information 282 according to the threshold voltage of each standard cell stored in the cell library 270 may include the amount of change in power of each standard cell according to the amount of change in threshold voltage of each transistor placed at the boundary of each standard cell. The power information 283 according to the mobility of each standard cell stored in the cell library 270 may include the amount of change in power of each standard cell according to the amount of change in mobility of each transistor placed at the boundary of each standard cell.

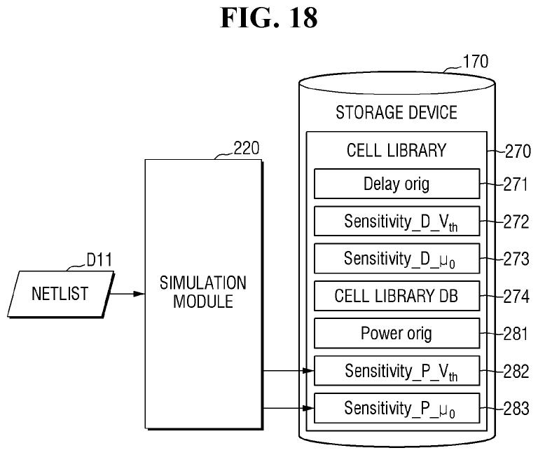

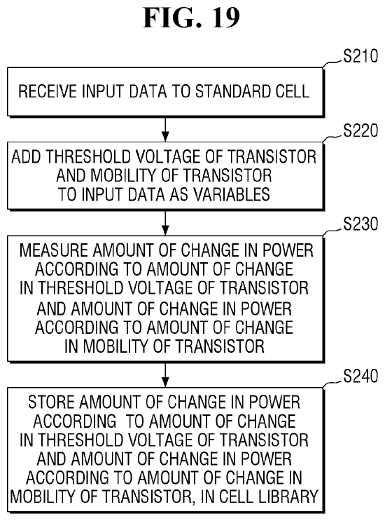

FIG. 18 is a diagram for explaining the method for designing the integrated circuit according to some embodiments. FIG. 19 is a flowchart for explaining the method for designing the integrated circuit according to some embodiments. FIG. 18 is a diagram that shows FIG. 16 in detail.

Referring to FIGS. 18 and 19, the simulation module 220 may receive the input data D11 for the standard cell (S210). The input data D11 may be a Netlist.

The simulation module 220 may add the threshold voltage of each transistor and the mobility of each transistor to the input data D11 as variables (S220). At this time, the simulation module 220 may perform step S220 on each transistor placed at the boundary of the standard cell.

The simulation module 220 may measure the amount of change (282) in power of the standard cell according to the amount of change in threshold voltage of each transistor and the amount of change (283) in power of the standard cell according to the amount of change in mobility of each transistor (S230). At this time, the simulation module 220 may perform step S230 on each transistor placed at the boundary of the standard cell.

The simulation module 220 may store the amount of change (282) in power of the standard cell according to the amount of change in threshold voltage of each transistor, and the amount of change (283) in power of the standard cell according to the amount of change in mobility of each transistor in the cell library 270 (S240).

The method for designing the integrated circuit according to some embodiments may characterize the power of the standard cell by the threshold voltage of the transistor and the mobility of the transistor.

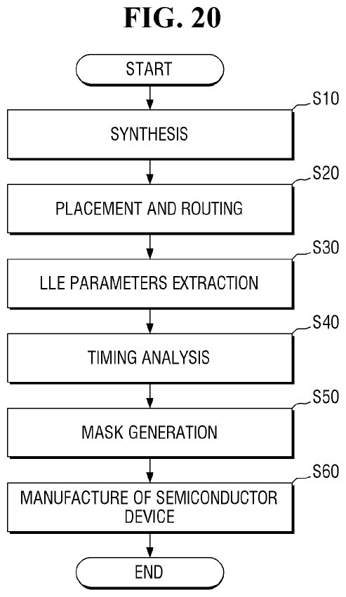

FIG. 20 is a flowchart for explaining the method for fabricating the semiconductor device according to some embodiments. For convenience of explanation, points different from those described using FIG. 3 will be mainly described.

Referring to FIG. 20, after the timing analysis of the integrated circuit is performed (S40), a mask may be generated on the basis of the layout data (S50). For example, the layout data may be modified on the basis of the timing report (D50 of FIG. 3) generated in step S40, and the mask may be generated according to the modified layout data. Specifically, an Optical Proximity Correction (OPC) that changes the layout by reflecting the error due to the optical proximity effect on the basis of the layout data may be performed. Subsequently, the mask may be fabricated according to the layout changed depending on the OPC execution result. At this time, the mask may be fabricated, using a layout that reflects the OPC, for example, GDS II that reflects the OPC.

A semiconductor device on which an integrated circuit is mounted using the mask may be fabricated (S60). Specifically, by performing various semiconductor processes on a semiconductor substrate such as a wafer using a plurality of masks, a semiconductor device in which an integrated circuit is mounted may be formed. For example, a process using the mask may mean a patterning process through a lithography process. A desired pattern may be formed on the semiconductor substrate or the material layer through such a patterning process. On the other hand, the semiconductor process may include a vapor deposition process, an etching process, an ion process, a cleaning process, and/or the like. Further, the semiconductor process may include a packaging process of mounting the semiconductor element on the printed circuit board (PCB) and sealing it with a sealing material, and/or may include a test process of testing the semiconductor element or the package.

In some embodiments, a computer program product comprising a non-transitory computer readable storage medium (e.g., the storage device 170 (FIG. 2) and/or the memory 130 (FIG. 1)) may have computer readable program code embodied in the medium that when executed by a processor (e.g., the processor 110 (FIG. 1)) causes the processor to perform any of the operations/methods described herein.

In concluding the detailed description, those skilled in the art will appreciate that many variations and modifications may be made to the example embodiments without departing from the scope of the invention. Therefore, the disclosed example embodiments of the disclosure are used in a generic and descriptive sense only and not for purposes of limitation.

1. A cell library that is stored in a non-transitory computer-readable storage medium,
wherein the cell library is configured to store:
first delay information of a standard cell according to a threshold voltage of a transistor included in the standard cell; and
second delay information of the standard cell according to mobility of the transistor included in the standard cell.

2. The cell library of claim 1,
wherein the first delay information includes an amount of change in a first delay of the standard cell according to an amount of change in the threshold voltage of the transistor included in the standard cell, and
wherein the second delay information includes a change in a second delay of the standard cell according to a change in the mobility of the transistor included in the standard cell.

3. The cell library of claim 1,
wherein the transistor is at a boundary of the standard cell,
wherein the standard cell is part of an integrated circuit, and
wherein a local layout effect (LLE) of the standard cell is defined by the first and second delay information, independently of a type of the LLE.

4. The cell library of claim 1,
wherein the transistor is a first transistor included in the standard cell,
wherein the standard cell further includes a second transistor,
wherein the first delay information includes:
delay information of the standard cell according to the threshold voltage of the first transistor; and
delay information of the standard cell according to a threshold voltage of the second transistor, and
wherein the second delay information includes:
delay information of the standard cell according to the mobility of the first transistor; and
delay information of the standard cell according to mobility of the second transistor.

5. The cell library of claim 1, wherein the cell library is further configured to store power information of the standard cell according to the threshold voltage of the transistor included in the standard cell.

6. The cell library of claim 1, wherein the cell library is further configured to store power information of the standard cell according to the mobility of the transistor included in the standard cell.

7. The cell library of claim 1, wherein the cell library is further configured to store third delay information with respect to a specific environment of the standard cell.

8. The cell library of claim 1,
wherein the standard cell is a first standard cell and the transistor is a first transistor, and
wherein the cell library is further configured to store:
delay information of a second standard cell according to a threshold voltage of a second transistor included in the second standard cell; and
delay information of the second standard cell according to mobility of the second transistor included in the second standard cell.

9. A computing system comprising:
a memory configured to store a program that designs an integrated circuit including a standard cell that includes a transistor; and
a processor configured to execute the program to:
receive input data of the standard cell;
measure an amount of change in a first delay of the standard cell according to an amount of change in threshold voltage of the transistor;
measure an amount of change in a second delay of the standard cell according to an amount of change in mobility of the transistor; and
store the amount of change in the first delay and the amount of change in the second delay, in a cell library.

10. The computing system of claim 9, wherein the transistor is at a boundary of the standard cell.

11. The computing system of claim 9,
wherein the transistor is a first transistor included in the standard cell,
wherein the standard cell further includes a second transistor,
wherein the processor is configured to measure an amount of change in delay of the standard cell according to an amount of change in a threshold voltage of the second transistor, and an amount of change in delay of the standard cell according to an amount of change in mobility of the second transistor, and
wherein the processor is configured to store the amount of change in the delay of the standard cell according to the amount of change in the threshold voltage of the second transistor, and the amount of change in the delay of the standard cell according to the amount of change in the mobility of the second transistor, in the cell library.

12. The computing system of claim 9,
wherein the cell library is configured to store a third delay of the standard cell with respect to a specific environment of the standard cell, and
wherein the processor is configured to combine the third delay with the amount of change in the first delay and the amount of change in the second delay.

13. The computing system of claim 9,
wherein the processor is configured to measure a first amount of change in power of the standard cell according to the amount of change in the threshold voltage of the transistor,
wherein the processor is configured to measure a second amount of change in power of the standard cell according to the amount of change in the mobility of the transistor, and
wherein the processor is configured to store the first and second amounts of change in the power.

14. The computing system of claim 9,
wherein the processor is configured to add the threshold voltage of the transistor and the mobility of the transistor to the input data as variables, and
wherein the processor is configured to change the variables and to measure the amount of change in the first delay and the amount of change in the second delay based on the changed variables.

15. A computing system comprising:
a memory configured to store a program for designing an integrated circuit; and
a processor configured to execute the program to:
place and route a plurality of standard cells that define the integrated circuit to generate layout data of the integrated circuit; and
calculate delay of the integrated circuit using an amount of change in delay of each of the plurality of standard cells according to an amount of change in threshold voltage of transistors included in each of the plurality of standard cells, and an amount of change in delay of each of the plurality of standard cells according to an amount of change in mobility of the transistors included in each of the plurality of standard cells.

16. The computing system of claim 15,
wherein the memory is configured to receive a local layout effect (LLE) model,
wherein the processor is configured to extract LLE parameters of each of the plurality of standard cells, and
wherein the processor is configured to input the LLE parameters to the LLE model to calculate the amount of change in the threshold voltage of the transistors included in each of the plurality of standard cells, and the amount of change in the mobility of the transistors included in each of the plurality of standard cells.

17. The computing system of claim 16,
wherein a cell library is configured to store a delay of each the plurality of standard cells with respect to a specific environment of each of the plurality of standard cells, and
wherein the processor is configured to calculate the delay of the integrated circuit, based on the delay of each of the plurality of standard cells with respect to the specific environment.

18. The computing system of claim 16, wherein the LLE parameters include at least one of:
presence or absence of an active pattern around each of the plurality of standard cells;
a shape of the active pattern around each of the plurality of standard cells;
a size of the active pattern around each of the plurality of standard cells; or
a distance between each of the plurality of standard cells and the active pattern around each of the plurality of standard cells.

19. The computing system of claim 15, wherein the processor is configured to calculate power of an integrated circuit, based on a first amount of change in power of each of the plurality of standard cells according to the amount of change in the threshold voltage of the transistors included in each of the plurality of standard cells, and a second amount of change in power of each of the plurality of standard cells according to the amount of change in the mobility of the transistors included in each of the plurality of standard cells.

20. The computing system of claim 19,
wherein the memory is configured to receive a local layout effect (LLE) model,
wherein the processor is configured to extract LLE parameters of each of the plurality of standard cells, and
wherein the processor is configured to input the LLE parameters to the LLE model to calculate the amount of change in the threshold voltage of the transistor included in each of the plurality of standard cells, and the amount of change in the mobility of the transistor included in each of the plurality of standard cells.

21-25. (canceled)
